(19) United States
(12) Patent Application Publication
(10) Pub. No.: US 2012/0228971 A1
(43) Pub. Date: Sep. 13, 2012

(54) ELECTRIC MOTOR, IN PARTICULAR A STARTER MOTOR FOR AN INTERNAL COMBUSTION ENGINE

(75) Inventors: Michael Bayer, Ludwigsburg (DE); Elisabeth Luger, Stuttgart (DE)

(73) Assignee: Robert Bosch GmbH, Stuttgart (DE)

(21) Appl. No.: 13/392,931

(22) PCT Filed: Aug. 27, 2010
(86) PCT No.: PCT/EP2010/062560

§ 371 Date: May 22, 2012

(30) Foreign Application Priority Data
Aug. 28, 2009 (DE) 10 2009 028 989.5

(51) Int. Cl. H02K 11/00

(52) U.S. Cl. 310/71

(57) ABSTRACT

The invention relates to an electric motor comprising an electric conductor for supplying current, connected to a contact piece which is in contact with a component of the electric motor. Said conductor has, in a central section, a rectangular cross-section.

### BACKGROUND OF THE INVENTION

The invention relates to an electric motor, in particular a starter motor for an internal combustion engine.

An electric starter motor for an internal combustion engine is described in DE 35 39 851 A1. In order to start the internal combustion engine, the armature of the electric starter motor is kinematically connected to a starter pinion, via which the crankshaft of the internal combustion engine is set in motion.

The power supply to the electric starter motor is generally provided via litz wires, which conventionally consist of copper and are electrically connected to the carbon brushes resting against the commutator. Since the carbon brushes are subject to wear, a tracking mechanism is generally provided for compensating for the wear, with it being necessary for the litz wires connected to the carbon brushes to also follow the tracking movement of the carbon brushes. Owing to vibrations and shocks as well as as a result of thermal influences, the litz wires are thus subjected to considerable loading, but this does not lead to failure or breakage of the litz wires over the life of the starter motor.

Usually, the litz wires which are connected to the carbon brushes and other litz wires which lead from a toe-in relay to a pole housing of the starter motor are in the form of braided litz wires with a round cross section, with it being necessary, owing to the installation situation, for the litz wires to be bent quite considerably, which results in an additional strain on the litz wires and in the risk of them coming into contact with other components. In addition, there is the risk of the braiding coming loose and, as a result, the litz wires fanning out.

### SUMMARY OF THE INVENTION

The invention is based on the object of designing the electrical connection in an electric motor to be permanent and robust with at the same time good matching to structural conditions in the electric motor.

The electric motor according to the invention is preferably an electric starter motor for an internal combustion engine, which is in the form of a mechanically commutated DC motor, for example. The motor has one or more brush pairs, which are in contact with a commutator, via which the current is conducted into the armature winding of the armature. The brushes are each connected to an electrical conductor for supplying current. Furthermore, electrical conductors are provided which lead from a relay to a component of the electric motor and from there, via the further conductor, to the brushes. The conductor which leads from the relay to the component of the electric motor, in particular a pole housing, is coupled to a contact piece, from where the further conductor also leads to the carbon brushes.

The invention provides that at least one conductor has a rectangular cross section in a central section and is welded to the contact piece in the region of an end-side end section. This end-side end section preferably likewise has a rectangular cross section, but this has different dimensions than the central section.

Various advantages are achieved by virtue of this embodiment. In contrast to the prior art, in which conventionally round cross sections are used in the electrical conductor, the conductor with the rectangular cross section has increased flexibility, which results in better matching to the installation situation. Despite the flexibility of the conductor, there is no risk of fanning out in the case of an embodiment of the conductor as a litz wire. The conductor with the rectangular cross section can be bent or twisted about different axes without this resulting in any damage to the conductor.

The dimensions in that end section of the conductor via which the conductor is welded to the contact piece differ from the dimensions of the rectangular, central section of the conductor. Provision is made in particular of the central section to be flatter, i.e. to have a greater width and a smaller height than the end section which is welded to the contact piece. In this embodiment, the end section has a cross-sectional geometry which is advantageous for the welding operation.

Expediently, both opposing end-side end sections of the conductor are each provided with a rectangular cross section, which differs from the central section in terms of the cross-sectional geometry or dimensions, in particular is less flat than the central section. It may be expedient for at least one of the end sections, possibly both end sections, to be provided with a square cross section, which is advantageous for the welding operation since the required welding site, with the result that the conductor can be welded to the end-side contact element in a space-saving manner.

In accordance with a further expedient embodiment, provision is made for at least one end-side end section, but preferably both end-side end sections, to be produced by reshaping of the rectangular cross section with which the central section of the conductor is provided. By virtue of this reshaping process, starting from a conductor with a cross section which is constant over the axial length, compacting of the end sections with a less pronounced rectangular cross section is achieved, with only the cross-sectional form changing, but the cross-sectional area remaining the same or at least approximately the same in the end sections as the cross-sectional area in the central section of the conductor.

In order to avoid or at least reduce mechanical and thermally induced stresses in the conductor, the transition from the wider, central section of the conductor to at least one narrower end section is advantageously provided with an angle of a maximum of 75°, with respect to the longitudinal axis of the conductor. This angle is 60° or 45°, for example. In this way, a comparatively uniform transition between the wider, central section and the narrower, end-side end section is ensured. Damage during compacting, in particular in the form of stiffening of the litz wire, is avoided by virtue of the angle in the transition region being limited.

In order to ensure sufficiently high flexibility of the conductor, it is expedient to provide a ratio of width to height of at least 3:2 in the region of the central section, with the result that the width is at least 1.5 times the height. If appropriate, an even greater ratio of width to height is selected, for example a ratio of 4:2, 5:2, 6:2 or even greater.

Expediently, both end sections are welded to contact elements, for example one end section of the conductor is welded to a cable lug and the opposite end section to the contact piece, which is guided with insulation (for example insulating rubber) through the pole housing of the electric motor. In the case of a current-conducting conductor which leads to the commutator of the electric motor, the conductor is connected to the carbon brush on the commutator side and is welded to the contact piece on the side opposite the commutator, said contact piece being guided in insulating fashion through the pole housing.

### BRIEF DESCRIPTION OF THE DRAWINGS

Further advantages and expedient embodiments can be gleaned from the further claims, the description relating to the figures and the drawings, in which:

FIG. 1 shows a schematic illustration of an electric motor with a pole housing, in which an armature revolves, wherein the supply of current to the electric motor takes place via a conductor in the form of a litz wire, which is connected at one end to a relay and at the other end, on the side of the electric motor, to a contact piece fastened on the outer side of the pole housing,

FIG. 2 shows a plan view of the litz wire,

FIG. 3 shows the litz wire in a side view,

FIG. 4 shows the litz wire in section,

FIG. 5 shows an enlarged detail in the transition region between one end side and the central section of the litz wire.

### DETAILED DESCRIPTION

The same components have been provided with the same reference symbols in the figures.

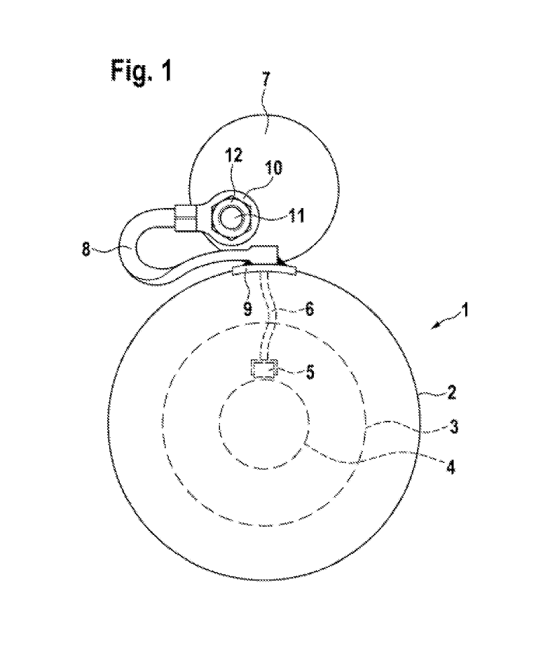

FIG. 1 illustrates an electric motor 1, which is in the form of a mechanically commutated DC motor and is used as a starter motor for internal combustion engines. The electric motor 1 has a revolving armature 3 in a pole housing 2, with magnets being arranged on the inner side of said pole housing, and said armature being provided with an energizable armature stack provided with coils, wherein the armature stack is energized via a commutator 4, with a carbon brush 5 resting against the outer side of said commutator and being connected to an electrical conductor in the form of a litz wire 6.

The supply of current to the electric motor 1 takes place starting from a relay 7 via an electrical conductor in the form of a litz wire 8, which is connected, in particular welded, to a contact piece 9 on the side of the electric motor, said contact piece being arranged on the outer side of the pole housing. The litz wire 6 via which current is supplied to the carbon brush 5 is also connected to the contact piece 9. The litz wire 8 is welded to a cable lug 10 at the other end, said cable lug being pushed onto a bolt 11 in the relay 7 and being secured by a nut 12.

The litz wire 8 and expediently also the litz wire 6 each have a rectangular cross section in a central section and a likewise rectangular or square cross section in the two end sections thereof. The subsequent FIGS. 2 to 5 show the litz wires 6 and 8 in a detail illustration. The litz wire 6, 8 comprises a central section 13 and end-side end sections 14 and 15, via which the litz wire is welded to the respective contact elements. The end-side end sections 14 and 15 have a cross section which differs from the central section 13. The central section 13, as can be seen from the sectional illustration shown in FIG. 4, is flat and has a comparatively large width b and a small height h, wherein the ratio of width b to height h is at least 3:2, but is possibly much greater in favor of a larger width. The end-side end section 14 has a square cross section, the opposite end-side end section 15 has a rectangular cross section, but is less flat than in the central section 13, with the result that the ratio of width to height of the end-side section 15 is smaller than in the central section 13.

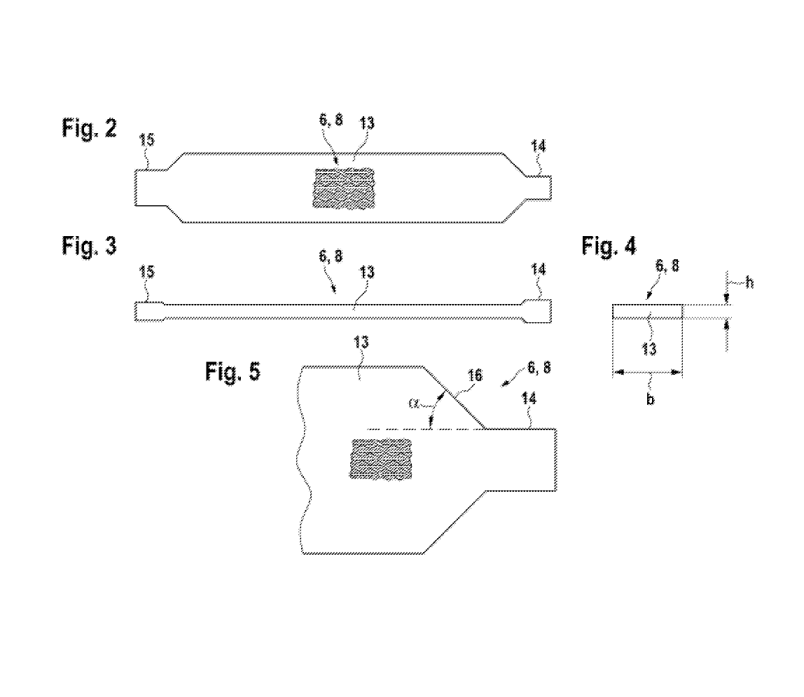

In the side view shown in FIG. 3, this different cross-sectional geometry manifests itself in the flat central section 13 and the slightly thicker end-side end sections 14 and 15, wherein one end-side end section 14 has a greater height owing to the square cross-sectional geometry than the opposite end-side end section 15 with a rectangular, non-square cross section. Since the end-side end sections 14 and 15 are produced by reshaping of the conductor, the end-side end sections 14 and 15 also have the same cross-sectional area as the central section 13.

FIG. 5 shows the transition 16 between one end-side end section 14 and the central section 13 in an enlarged illustration. In order in particular to avoid damage during compacting, the transition 16 has an angle a with respect to the longitudinal axis of the conductor which is a maximum of 75°. In the exemplary embodiment, the angle α is approximately 45°.

1. An electric motor, comprising an electrical conductor for a power supply, the conductor being connected to a contact piece (9) which is in contact with a component of the electric motor (1), characterized in that the conductor has a rectangular cross section in a central section (13).

2. The electric motor as claimed in claim 1, characterized in that the conductor is welded to the contact piece (9) in the region of an end-side end section (14, 15), the end-side end section (14, 15) having a rectangular cross section, but with different dimensions than the central section (13).

3. The electric motor as claimed in claim 1, characterized in that the conductor is in the form of a litz wire (6).

4. The electric motor as claimed in claim 1, characterized in that two end-side end sections (14, 15) of the conductor each have a rectangular cross section with different dimensions than the central section (13).

5. The electric motor as claimed in claim 4, characterized in that the rectangular cross sections of the end sections (14, 15) are produced by reshaping.

6. The electric motor as claimed in claim 1, characterized in that the central section (13) of the conductor is flatter and has a greater width and a lower height than at least one end section (14, 15).

7. The electric motor as claimed in claim 6, characterized in that an angle (α) at the transition from the wider central section (13) of the conductor to at least one narrower end section (14, 15) is a maximum of 75°.

8. The electric motor as claimed in claim 1, characterized in that the ratio of width to height of the central section (13) of the conductor is at least 3:2.

9. The electric motor as claimed in claim 1, characterized in that an end section (14, 15) of the conductor has a square cross section.

10. The electric motor as claimed in claim 1, characterized in that two end sections (14, 15) of the conductor are welded to contact elements (9, 10).

11. The electric motor as claimed in claim 1, characterized in that one end section (14, 15) of the conductor is connected to a cable lug (10).

12. The electric motor as claimed in claim 1, characterized in that the contact piece (9) is connected in insulated fashion to a pole housing (2) of the electric motor (1).

13. The electric motor as claimed in claim 1, characterized in that a conductor (6) is connected to a carbon brush (5), which is in contact with a commutator (4) fixed to an armature.
